(19) United States
(12) Patent Application Publication
(10) Pub. No.: US 2020/0027316 A1
(43) Pub. Date: Jan. 23, 2020

(54) MODIFIED BACCARAT GAME

(71) Applicant: A8 Game Limited, Wan Chai (HK)

(72) Inventors: Zhenhui HUANG, Tsuen Wan (HK); Kenneth Kwok Wah LIU, So Kwun Wat (HK)

(21) Appl. No.: 16/144,010

(22) Filed: Sep. 27, 2018

Related U.S. Application Data
(60) Provisional application No. 62/702,010, filed on Jul. 23, 2018.

(51) Int. Cl. G07F 17/32

(52) U.S. Cl. CPC G07F 17/3293; G07F 17/322; G07F 17/3262; G07F 17/3248

(57) ABSTRACT

A method for playing a modified Baccarat card game includes providing a gaming table or electronic gaming system (including via the internet) having a side bet wager spot for receiving a Bigger Win side bet that either the Player hand or the Banker hand will have a higher point value based on a scoring system different from the rules of a standard Baccarat game, having other side bet options such as Win Both side bet and In-Between side bet, receiving one or more Variable Value Tokens from a gambler, the Variable Value Tokens having an initial face value that is more than the initial cost that was paid by the gambler, determining whether the wager placed in the step of receiving is a winning wager in the Baccarat game and on the Bigger Win side bet and other side bets (if any), and dispensing a payout.

### CROSS-REFERENCE TO RELATED APPLICATION

This application claims priority from U.S. Provisional Patent Application Ser. No. 62/702,010 filed on Jul. 23, 2018, which is incorporated herein by reference in its entirety.

### TECHNICAL FIELD

This invention relates to a modified Baccarat game. The modified Baccarat game includes one or more alternative side bets in addition to standard bets available in known Baccarat games.

### BACKGROUND

Baccarat is a popular casino game, with a popular version being punto banco Baccarat. The standard rules of Baccarat are known, and generally include the use of established rules with the object of getting closest to a point total of 9. Based on the established rules, cards are dealt first to the “Player,” then to the “Banker,” then to the Player (if necessary) and then to the Banker (if necessary). The outcomes are Player win, Banker win, or a “Tie”. These outcomes allow for a natural as a point value of either 8 or 9 with the first two cards used.

Many versions of modified Baccarat games have been developed. For example, U.S. Pat. No. 8,573,597 discloses a method of playing Baccarat including a side bet, which has a payout based on an occurrence of a natural 8-count or 9-count that loses if either no natural occurs, or bettors chose a side that did not have a natural. U.S. Pat. No. 5,362,064 also discloses a Baccarat game with side bets, including a specific side bet where a natural tie pays 50:1. U.S. Pat. Nos. 6,789,801 and 5,395,119 are other examples of Baccarat games offering side bets. However, there remains a need in the art for a further improved Baccarat game.

### DISCLOSURE OF THE INVENTION

It is thus an object of the present invention to provide a Baccarat game that is more entertaining for a user to play.

It is another object of the present invention to provide a Baccarat game that will increase the revenue for a casino.

These and other objects of the present invention, as well as the advantages thereof over existing prior art forms, which will become apparent from the description to follow, are accomplished by the improvements hereinafter described and claimed.

In general, a method for playing a modified Baccarat card game includes providing a gaming table or electronic gaming system. The gaming table or electronic gaming system includes a Player hand area for receiving cards for a Player hand, a Banker hand area for receiving cards for a Banker hand. The gaming table or electronic gaming system includes a gambling wager area having a Player primary wager spot for receiving a wager on the Player hand to win a Baccarat game, a Banker primary wager spot for receiving a wager on the Banker hand to win the Baccarat game, a Tie primary wager spot for receiving a wager on a tie between the Banker hand and the Player hand, and a side bet wager spot for receiving a Bigger Win side bet that either the Player hand or the Banker hand will have a higher point value based on a scoring system different from the rules of the Baccarat game. The method further includes receiving from a gambler on at least one of the wager spots, one or more Variable Value Tokens, the Variable Value Tokens having an initial face value that is more than the initial cost that was paid by the gambler. Next steps include dealing the Player hand in the Player hand area and the Banker hand in the Banker hand area according to standard Baccarat rules, determining whether a winning hand in the Baccarat game is the Player hand or the Banker hand, and determining whether the winning hand in the Baccarat game is the same as the wager placed in the step of receiving. Responsive to the outcome of the Baccarat game and according to predetermined rules for the Bigger Win side bet, a method includes determining whether the wager placed in the step of receiving is a winning wager in the Baccarat game and on the Bigger Win side bet, and dispensing a payout according to a predetermined payout table if the wager placed in the step of receiving is a winning wager. The gambler can redeem the Variable Value Tokens for a current monetary value, and the redemption of the Variable Value Tokens may be subject to one or more conditions.

A preferred exemplary design for playing the modified Baccarat game according to the concepts of the present invention is shown by way of example in the accompanying drawing without attempting to show all the various forms and modifications in which the invention might be embodied, the invention being measured by the appended claims and not by the details of the specification.

### BRIEF DESCRIPTION OF THE DRAWINGS

FIG. 1 is a schematic of a design for playing the modified Baccarat game according to the concepts of the present invention.

### PREFERRED EMBODIMENT FOR CARRYING OUT THE INVENTION

Embodiments of the present invention relate to a modified Baccarat game. As used in this specification, and as generally known for the standard manner in which Baccarat is described, the terms “Player” and “Banker” are designations of the hands dealt in each round, and the outcomes that can be wagered upon. That is, “Player” has no particular association with any individual gambler, nor does “Banker” have any particular association with the casino or dealer.

As used in the specification, the term “Baccarat” may be said to describe the standard punto banco form of Baccarat, all other known varieties of Baccarat (for example, Mini-Baccarat, Midi-Baccarat, Chemin de Fer, Baccarat Banque) and all suitable forms known hereafter. That is, the side bets described herein may be utilized with any form of Baccarat, and with any other suitable casino gambling card game. The standard form of Baccarat may also be described herein as the “primary” Baccarat game.

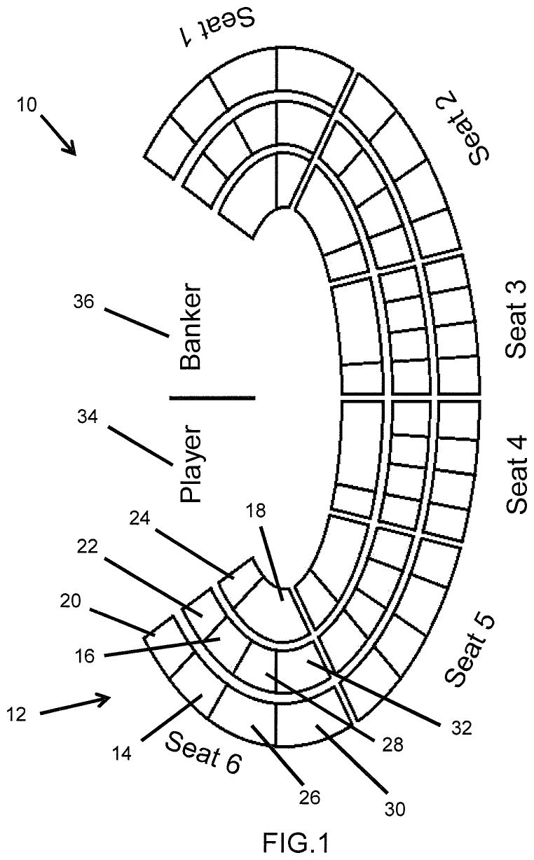

As will be further described herein, the operations of the modified Baccarat game can be performed by (1) a human dealer in a casino gaming environment (for example, using the table design shown in FIG. 1) or (2) by a gaming machine configured in accordance with generally known online gaming systems communicating with a device used by the gambler (including a computerized betting terminal system allowing gamblers to play multiple and different live table games with a live dealer via remote terminals, as generally known in the art) or (3) by an online gaming system where gamblers play on the internet via a computer, mobile device, or application. In either a gaming machine embodiment or an online gaming system embodiment, any utilized program code and modules implementing the functionality described herein are not native components of the underlying machine or system, and thus extend the operations and functionality thereof beyond their generic functions and capabilities. As generally known in the art, a gaming machine embodiment or an online gaming system embodiment may be connected via the internet.

Bigger Win Side Bet

A modified Baccarat game may include a Bigger Win side bet. The Bigger Win side bet provides an option for betting on whether the total value of the first two cards of the Player hand or the first two cards of the Banker hand for the standard Baccarat game will be higher. The determination of which hand is higher is based on rules different from the standard Baccarat rules. Cards with values 2-10 are worth their face value in points, Jack face cards are worth 11 points, Queen face cards are worth 12 points, King face cards are worth 13 points, and Ace's are worth 1 point. For example, the value of a hand having a 5 card and a King card is worth 18, which would beat a hand having a 2 card and a Queen card, which has a total value of 14. In some embodiments, a two card hand where the two cards match in numerical value, that is, form a pair, ranks higher than a non-paired hand. For example, a hand having a first 3 card and a second 3 card (otherwise having a value of 6) would beat a hand having a 2 card and a Queen card, which has a total value of 14. In some of these embodiments, paired hands are ranked based on the value of the individual cards; that is, a pair of Kings is the highest pair and a pair of Aces is the lowest pair. In other embodiments, a pair of Aces may be the highest pair.

The Bigger Win side bet may also include an option for the player to bet that the value or rank of the Player hand and Banker hand will be tied. For example, a tie bet would win if a first hand includes a 2 card and a 3 card and a second hand includes a 1 card and a 4 card, each hand having a value of 5. In some embodiments, the payout for a winning tie bet in the Bigger Win side bet is 11:1.

The outcome of the Bigger Win will be determined once the first two cards of the Player hand and the first two cards of the Banker hand for the standard Baccarat game are revealed. If, according to the standard Baccarat game rules, a third card needs to be drawn into either hand, a wager placed on the Bigger Win side bet may be resolved either before or after completing the primary Baccarat game.

Win Both Side Bet

In some embodiments, the Bigger Win side bet may include an option for a gambler to wager that he will win both the primary wager and the Bigger Win side bet on either the Player hand or the Banker hand. This may be referred to as a Win Both side bet. In order to place a wager on the Win Both side bet, the gambler is required to have placed the wagers on both the primary wager in Baccarat (i.e. Player or Banker) and the Bigger Win side bet on the same hand. The gambler wins the Win Both side bet if he wins both the primary Baccarat wager and the Bigger Win side bet, which will be for the same hand (i.e. both for the Player hand or the Banker hand). As an example, standard Baccarat payouts for the primary wager are 1:1 for Player hand and 1:1 with a commission to the casino for the Banker hand. A Bigger Win side bet may also utilize the payout of 1:1 for Player hand and 1:1 with a commission to the casino for the Banker hand. For the Win Both side bet, the payout may be 2:1 or any other suitable rates above 2:1.

Variable Value Token

A modified Baccarat game may include the use of one or more Variable Value Tokens. A gambler pays a predetermined value, that is, an “initial cost”, for the Variable Value Tokens. The total face value of the Variable Value Tokens is then determined by adjusting the initial cost paid by the gambler by a multiplier. In some embodiments, the total face value of the Variable Value Tokens is double the initial cost paid by the gambler. For example, when the gambler pays $100, the total face value of the Variable Value Tokens he receives will be $200. The multiplied face value of the Variable Value Tokens may be any suitable amounts. As said above, in certain examples, the multiplied face value may be 2:1. In some embodiments, the multiplied face value may be in a range of from 2:1 to 10:1. In other examples, the multiplied face value may be 10:1. The term or expression “Variable Value Tokens” used herein should be understood as including one or any number of tokens, chips, coins or the like. Each one of the Variable Value Tokens may be assigned any value, such as $5, $25, $100, $500, $1,000, $10,000, etc. In some embodiments, the Variable Value Tokens may be electronic.

The Variable Value Tokens may then be used by a gambler to wager on the modified Baccarat game described herein. The Variable Value Tokens must be purchased and wagered by a gambler before dealing the modified Baccarat game. The Variable Value Tokens may be used on any of the available wagers in the modified Baccarat game.

The Variable Value Tokens may be redeemed for money after the gambler has played one or more rounds of the modified Baccarat game. In some embodiments, the gambler may be required to win a cumulative total value amount (that is, over the course of multiple games) that is a predetermined multiplier of the initial face value of the Variable Value Tokens (that is, a value ‘turnover’) before the Variable Value Tokens can be redeemed. In some embodiments, when redeeming the Variable Value Tokens, the gambler is not required to reimburse the casino for the multiplied face value that was realized upon purchasing the Variable Value Tokens. The Variable Value Tokens may be redeemed entirely for money at any subsequent face value, regardless of the initial face value.

This redemption of the Variable Value Tokens for money may be subject to one or more conditions. In some embodiments, the redemption of the Variable Value Tokens is subject to one or more of the following conditions:

1. Variable Value Tokens' Current Face Value: ≥200% of the Initial Face Value
When the gambler utilizes the Variable Value Tokens to play the modified Baccarat game and the Variable Value Tokens accumulate a current face value double or more than the initial face value of the Variable Value Tokens, the gambler may redeem the Variable Value Tokens for money for 100% of the current face value of the Variable Value Tokens. For example, the gambler pays $100 as an initial cost and receives Variable Value Tokens with a total initial face value of $200. After playing several rounds of the modified Baccarat game, the gambler has a net positive win and the Variable Value Tokens have accumulated a current face value of $400 (or above). In such instance, the gambler may opt to redeem the entirety of the current face value of the Variable Value Tokens for money in the equivalent value, i.e. $400.

2. Variable Value Tokens' Current Face Value: <200% of the Initial Face Value and >50% of the Initial Cost
When the gambler utilizes the Variable Value Tokens to play the modified Baccarat game and the Variable Value Tokens accumulate a current face value that is between half of the initial cost of the Variable Value Tokens (that was paid by the gambler) and just less than double the initial face value of the Variable Value Tokens, the gambler may redeem the Variable Value Tokens for money for 50% of the current face value of the Variable Value Tokens. For example, the gambler pays $100 as an initial cost and receives Variable Value Tokens with a total initial face value of $200. After playing several rounds of the modified Baccarat game, the Variable Value Tokens have accumulated a current face value of between $50 and $400 (non-inclusive of the end points). In such instance, the gambler may opt to redeem the entirety of the current face value of the Variable Value Tokens for money equivalent to 50% of the current face value, i.e. $199.50 if the current face value is $399.

3. Variable Value Tokens' Current Face Value: ≤50% and >0% of the Initial Cost
When the gambler utilizes the Variable Value Tokens to play the modified Baccarat game and the Variable Value Tokens accumulate a current face value that is between zero and half (inclusive) of the initial cost of the Variable Value Tokens (that was paid by the gambler), the gambler may redeem the Variable Value Tokens for money for 100% of the current face value of the Variable Value Tokens. For example, the gambler pays $100 as an initial amount and receives Variable Value Tokens with a total initial face value of $200. After playing several rounds of the modified Baccarat game, the gambler has a net negative loss and the Variable Value Tokens have accumulated a current face value of between $0 (non-inclusive of the end point) and $50 (inclusive of the end point). In such instance, the gambler may opt to redeem the entirety of the current face value of the Variable Value Tokens for money in the equivalent value, i.e. $50 if the current face value is $50.

4. Lost all Value of the Variable Value Tokens
When the gambler utilizes the Variable Value Tokens to play the modified Baccarat game and the Variable Value Tokens are reduced to a current face value of zero, the gambler is not required to pay for the premium value received (that is, the multiplier of the initial cost) for the Variable Value Tokens. The gambler may choose to leave the game or purchase more Variable Value Tokens to play.

5. Rolling Chip Turnover≥500% of the Variable Value Tokens' Initial Face Value
As said above, in some embodiments, the gambler may be required to win a cumulative total value amount (that is, over the course of multiple games) that is a predetermined multiplier of the initial face value of the Variable Value Tokens (that is, a value ‘turnover’) before the Variable Value Tokens can be redeemed. In certain embodiments, the turnover the gambler must win must be five times (or above) the initial face value of the Variable Value Tokens. Once this turnover is achieved, the gambler may then redeem the entirety of the current face value of the Variable Value Tokens for money for 100% of the current face value. For example, the gambler pays $100 as an initial cost and receives Variable Value Tokens with a total initial face value of $200. After playing several rounds of the modified Baccarat game, the gambler has wagered a total amount of $1,000 or above, and the current face value of the Variable Value Tokens is $300. In such instance, the gambler may opt to redeem the entirety of the current face value of the Variable Value Tokens for money in the equivalent value, i.e. $300.
   In some embodiments, the redemption of the Variable Value Tokens is subject to all 5 of the above conditions.

Because the initial face value for the Variable Value Tokens is higher than the amount paid for the Variable Value Tokens, the Variable Value Tokens may have the effect of attracting additional gamblers to participate in the modified Baccarat game and increasing the level of excitement for the gamblers.

In some embodiments, using the Variable Value Tokens may require both a commission for a winning Player hand wager and a higher commission for a winning Banker hand wager (that is, higher than the standard 5% commission) to be paid to the casino. For example, using the Variable Value Tokens on a winning wager may require a commission of 10% for the Player hand wager and 15% for the Banker hand wager to be paid to the casino. Any suitable commission percentage higher than 0% for the Player hand wager and the standard 5% for the Banker hand may be utilized. In some embodiments, any suitable commission (e.g. 10%) may be required to be paid when the Variable Value Tokens are used for a winning side bet wager.

In Between Side Bet

A modified Baccarat game may include an In Between side bet. The In Between side bet provides an option for betting on whether a third card (when a third card is drawn in accord with the standard Baccarat rules) will be in between the first two cards of the Player hand or the Banker hand. That is, the standard rules for Baccarat include drawing two initial cards for the Player hand and two initial cards for the Banker hand. Based on the values of these initial cards, the standard rules for Baccarat sometimes call for additional cards to be drawn by the Player, Banker, or both. When a third card needs to be drawn for either or both of the Player hand and the Banker hand, a gambler may be given the option to bet whether the third card will fall in between the initial two cards. The gambler may bet that the third card will fall in between or that the third card will not fall in between the initial two cards. This side bet may be made for either or both of the Player hand and the Banker hand. This In Between side bet is made after the initial two cards of the Player hand and the Banker hand have been dealt. The payout amounts for a winning bet will be based the range between the initial cards.

In some embodiments, the payouts for the In Between side bet may be dispensed according to the following table.

| Range between the initial cards | Payout |
|---|---|
| 7-11 | 0.5:1 |
| 3-6 | 1:1 |
| 1-2 | 2:1 |

For purposes of this specification, the above described Bigger Win side bet, Win Both side bet, In Between side bet, and any combination thereof, may be referred to as “side bet,” “a side bet,” “the side bets,” “each side bet,” and “one or more side bets.”

Method

A method of playing the modified Baccarat game will now be described. The modified Baccarat game is initiated by the dealer calling for wagers, or by the gambler initiating a gaming round on a gaming machine, for example by depositing funds and selecting an option to start a game. This may be described as a first step of receiving wagers from the gambler. A gambler can place one or more wagers for the game, including one or more of a primary wager on the outcome of the Baccarat hand and one or more of the side bets described herein. A gambler may utilize the Variable Value Tokens. The primary wager is made to participate in the primary Baccarat game. Any combination of the above described side bets may be utilized in a modified Baccarat game.

In certain embodiments, the gambler must make the primary wager on the standard Baccarat game to enable or otherwise be eligible to make the side bets. In one or more of these embodiments, the gambler can only place a side bet on the same hand as a primary wager had been placed. For example, in these embodiments, if the gambler makes a primary wager on the Player hand, only a side bet can be placed on Player, but if the gambler places a primary wager on a Tie, then a side bet can be placed on either the Player or the Banker.

In another version, a primary wager is required, but the gambler may make a side bet on either the Player or Banker hand. For example, the gambler can make a primary wager on the Player hand to win, and a side bet on the Banker hand.

In other versions, the gambler may make one or more side bets without making any primary wager on the standard Baccarat game.

After all gamblers have made their respective one or more primary wagers and side bet wagers, the method proceeds to dealing the Player and Banker hands according to the standard Baccarat rules, for example, according to the rules for punto banco Baccarat. This includes any rules for drawing cards by the Player and Banker hands, until the Baccarat rules indicate the entire hand is completed.

In some gaming machine or gaming system embodiments, a pseudo-random number generator (PRNG) integrated circuit may be used to select a random value, which is then used to select the cards from data structure (e.g., a stored data table, array, trei, linked list, tree, or other memory structure) stored in non-transitory computer memory representing a deck (or a plurality of decks) of cards available for dealing. Given the selected card (suit and value) a graphics processor coupled to the memory generates graphical symbols representing the selected cards, which are then selectively displayed on the display device. The pay tables may be programmatically encoded using stored data tables, conditional logic, or programmatic equivalents.

After the entire hand has been dealt, the outcome of the primary wager on the Baccarat hand is determined according to the Baccarat rules. Stated again, this can be done by the dealer, gaming machine, or online gaming system with corresponding program code modules implementing an algorithm that programmatically embodies the rules of Baccarat. In accord with standard Baccarat rules, for the primary wager, cards with values 2-9 may be worth their face value in points, face cards and 10's may be worth 0 points, and an ace may be worth 1 point.

The point totals for the Player hand and Banker hand are calculated to arrive at the final value of each hand. The hand with the greater final point value is the winning hand, and the results of the primary wager are determined based on which of the Player hand and Banker hand is the winning hand. As generally known, a Tie would occur if the final point value of the Player hand and the Banker hand were the same. The outcomes are thus Player wins, Banker wins, or Tie. The primary wagers are then paid or collected according to the rules of Baccarat.

As described above, the Bigger Win side bet will be determined once the first two cards for both the Player hand and the Banker hand are revealed. Thus, the Bigger Win side bet may be paid or collected after the first two cards of the Player hand and the Banker hand are drawn, or after the standard Baccarat game is completed.

Similar to certain known Baccarat games, in a modified Baccarat game a gambler may also be able to wager on whether the first two cards for both the Player hand and the Banker hand will be a matching pair. This wager may be paid out according to standard pay tables and may be paid or collected after the first two cards of the Player hand and the Banker hand are drawn, or after the standard Baccarat game is completed.

In accord with the modified Baccarat game, the outcomes of any offered side bets are determined, based on the features of the Player hand and the Banker hand corresponding to the side bets, and respective payouts are dispensed for winning wagers and respective side bet wagers are collected for losing wagers. Predetermined pay table amounts for the side bets may be utilized.

Table Design

As previously described, a modified Baccarat game according to concepts of the invention may be utilized as a table game or with a gaming machine or online gaming system. With reference to FIG. 1, a design 10, which may also be described as a gaming surface 10, is provided, which may be for a table of a table gaming embodiment or for a screen of a gaming machine or online gaming system. Design 10 may be printed on a table or may be part of a graphic for a gaming machine or online gaming system.

Gaming surface 10 includes a plurality of gambler locations 12 such that multiple gamblers may be a part of a single modified Baccarat game. Though FIG. 1 shows gaming surface 10 with six gambler locations 12, any suitable number of gambler locations 12 may be used. In certain embodiments, gaming surface 10 may include four gambler locations 12 or eight gambler locations 12. In other embodiments, a design for a modified Baccarat game may include only a single gambler location 12 particularly adapted for a single gambler playing the modified Baccarat game.

Within gambler location 12, which may also be described as a gambling wager area 12, a gambler designates one or more wagers by placing chips or tokens in fixed, predetermined locations, which may also be described as wager spots. Gambling wager area 12 includes primary wager spots corresponding to the primary Baccarat game. This includes a Player primary wager spot 14 for receiving a wager on the Player hand to win a Baccarat game, a Banker primary wager spot 16 for receiving a wager on the Banker hand to win the Baccarat game, and a Tie primary wager spot 18 for receiving a wager on a tie between the Banker hand and the Player hand.

Gambling wager area 12 further includes wager spots for wagering on the Bigger Win side bet, as described above. This includes a Player Bigger Win wager spot 20 for receiving a wager on the Player hand to win the Bigger Win side bet, a Banker Bigger Win wager spot 22 for receiving a wager on the Banker hand to win the Bigger Win side bet, and a Tie Bigger Win wager spot 24 for receiving a wager on a tie between the Banker hand and the Player hand for the Bigger Win side bet.

Gambling wager area 12 further includes wager spots for wagering on the Win Both side bet, as described above. This includes a Player Win Both wager spot 26 for receiving a wager on the Player hand to win the Win Both side bet, and a Banker Win Both wager spot 28 for receiving a wager on the Banker hand to win the Win Both side bet.

Gambling wager area 12 further includes wager spots for wagering on the In Between side bet, as described above. This includes a Player In Between wager spot 30 for receiving a wager on the In Between side bet for the Player hand, and a Banker In Between wager spot 32 for receiving a wager on the In Between side bet for the Banker hand.

Though not shown with a particular wager location, a gambler may utilize the Variable Value Tokens with gambling wager area 12. In some embodiments, the Variable Value Tokens may be limited to wagering in Player primary wager spot 14 and Banker primary wager spot 16. In other embodiments, the Variable Value Tokens may be used for any wager spot within gambling wager area 12.

For receiving cards for the modified Baccarat game, gaming surface 10 includes a Player hand area 34 for receiving cards for a Player hand and a Banker hand area 36 for receiving cards for a Banker hand.

Further details of primary Baccarat, gaming machine, and/or online gaming system embodiments may be disclosed in U.S. Pat. No. 9,950,246, which is incorporated herein by reference. For example, in gaming machine or online gaming system embodiments, the wagers are made by first selecting a number of credits available to the gambler from a credit balance on the gaming machine or gaming system. The wager spots would be provided on a user interface shown in a display device coupled to the gaming machine, or the gambler's client device. The gambler would use an input device (for example, mouse or touchscreen) to graphically manipulate and designate one or more wagers.

It is thus evident that a modified Baccarat game as described herein accomplishes the objects of the present invention and otherwise substantially improves the art.

What is claimed is:

1. A method for playing a modified Baccarat card game comprising:
providing a gaming table or electronic gaming system having a Player hand area for receiving cards for a Player hand, a Banker hand area for receiving cards for a Banker hand, a gambling wager area comprising a Player primary wager spot for receiving a wager on the Player hand to win a Baccarat game, a Banker primary wager spot for receiving a wager on the Banker hand to win the Baccarat game, a Tie primary wager spot for receiving a wager on a tie between the Banker hand and the Player hand, and a side bet wager spot for receiving a Bigger Win side bet that either the Player hand or the Banker hand will have a higher point value based on a scoring system different from the rules of the Baccarat game,
receiving from a gambler on at least one of the wager spots, one or more Variable Value Tokens, the Variable Value Tokens having an initial face value that is more than the initial cost that was paid by the gambler;
dealing the Player hand in the Player hand area and the Banker hand in the Banker hand area according to standard Baccarat rules, wherein the standard Baccarat rules utilize rules of punto banco Baccarat;
determining whether a winning hand in the Baccarat game is the Player hand or the Banker hand;
determining whether the winning hand in the Baccarat game is the same as the wager placed in the step of receiving;
responsive to the outcome of the Baccarat game and according to predetermined rules for the Bigger Win side bet, determining whether the wager placed in the step of receiving is a winning wager in the Baccarat game and on the Bigger Win side bet,
dispensing a payout according to a predetermined payout table if the wager placed in the step of receiving is a winning wager, and
allowing the gambler to redeem the Variable Value Tokens for a current monetary value, wherein the step of allowing the gambler to redeem is subject to one or more conditions.

2. The method of claim 1, wherein the initial face value of the Variable Value Tokens is at least double the initial cost of the Variable Value Tokens that was paid by the gambler.

3. The method of claim 2, wherein the initial face value of the Variable Value Tokens is in a range of from 2:1 to 10:1 of the initial cost of the Variable Value Tokens that was paid by the gambler.

4. The method of claim 1, wherein a first condition of the one or more conditions is that the gambler may perform the step of redeeming the Variable Value Tokens for 100% of the current monetary value if the current monetary value of the Variable Value Tokens is twice or more the initial face value of the Variable Value Tokens.

5. The method of claim 1, wherein a second condition of the one or more conditions is that the gambler may perform the step of redeeming the Variable Value Tokens for 50% of the current monetary value if the current monetary value of the Variable Value Tokens is in a range of from half of the initial cost of the Variable Value Tokens (that was paid by the gambler) to twice the initial face value of the Variable Value Tokens (non-inclusive of the end points).

6. The method of claim 1, wherein a third condition of the one or more conditions is that the gambler may perform the step of redeeming the Variable Value Tokens for 100% of the current monetary value if the current monetary value of the Variable Value Tokens is equal to or less than half the initial cost of the Variable Value Tokens (that was paid by the gambler) and more than zero.

7. The method of claim 1, wherein when the current monetary value of the Variable Value Tokens has been reduced to zero, a fourth condition of the one or more conditions is that the gambler may select from leaving the modified Baccarat game and purchasing one or more Variable Value Tokens to continue playing the modified Baccarat game.

8. The method of claim 7, wherein the gambler is not required to pay for the amount of the initial face value that was more than the initial cost.

9. The method of claim 1, wherein a fifth condition of the one or more conditions is that the gambler may perform the step of redeeming the Variable Value Tokens for the current monetary value only if a cumulative total amount won by the gambler is an amount at least five times the initial face value of the Variable Value Tokens.

10. The method of claim 9, wherein the current monetary value of the Variable Value Tokens during the step of redeeming may be any amount regardless of the initial face value.

11. The method of claim 1, wherein the scoring system different from the rules of the Baccarat game includes a scoring system of cards with face values of 2-10 are worth their face value in points, Jack face cards are worth 11 points, Queen face cards are worth 12 points, King face cards are worth 13 points, and Aces are worth 1 point.

12. The method of claim 11, wherein the scoring system different from the rules of the Baccarat game includes a scoring system where a two card hand having two cards matching in numerical value ranks higher than a two card hand without matching numerical value cards.

13. The method of claim 12, wherein the scoring system different from the rules of the Baccarat game includes a scoring system where a two card hand having two King face cards ranks as a highest rank hand.

14. The method of claim 13, wherein the Bigger Win side bet includes an option for the gambler to wager that the value of the Player hand and Banker hand will be tied according to the scoring system different from the rules of the Baccarat game.

15. The method of claim 1, further comprising an additional side bet wager spot for receiving a Win Both side bet that the gambler will win both the primary Baccarat wager and the Bigger Win side bet wager on the Player hand or that the gambler will win both the primary Baccarat wager and the Bigger Win side bet wager on the Banker hand.

16. The method of claim 1, further comprising an additional side bet wager spot for receiving an In Between side bet that a third card drawn into the Player hand or the Banker hand will be in between two prior cards drawn into the Player hand or Banker hand respectively.

17. The method of claim 16, wherein the additional side bet wager spot for receiving an In Between side bet includes a first wager spot for receiving an In Between side bet that a third card drawn into the Player hand will be in between two prior cards drawn into the Player hand, and a second wager spot for receiving an In Between side bet that a third card drawn into the Banker hand will be in between two prior cards drawn into the Banker hand.

18. The method of claim 1, wherein the Variable Value Tokens must be purchased and wagered by a gambler before the step of dealing.

19. The method of claim 1, wherein, based on the Variable Value Tokens being wagered, a commission for a winning Player hand wager is required to be paid to the casino, wherein the Baccarat game requires a standard commission on a winning Banker hand to be paid, wherein, based on the Variable Value Tokens being wagered, a higher commission percentage than the standard commission for a winning Banker hand wager is required to be paid to the casino.

20. A method for playing a modified Baccarat card game comprising:
providing a gaming table or electronic gaming system having a Player hand area for receiving cards for a Player hand, a Banker hand area for receiving cards for a Banker hand, a gambling wager area comprising a Player primary wager spot for receiving a wager on the Player hand to win a Baccarat game, a Banker primary wager spot for receiving a wager on the Banker hand to win the Baccarat game, a Tie primary wager spot for receiving a wager on a tie between the Banker hand and the Player hand, and a side bet wager spot for receiving a Bigger Win side bet that either the Player hand or the Banker hand will have a higher point value based on a scoring system different from the rules of the Baccarat game,
receiving from a gambler on at least one of the wager spots, one or more Variable Value Tokens, the Variable Value Tokens having an initial face value that is more than the initial cost that was paid by the gambler;
dealing the Player hand in the Player hand area and the Banker hand in the Banker hand area according to standard Baccarat rules, wherein the standard Baccarat rules utilize rules of punto banco Baccarat;
determining whether a winning hand in the Baccarat game is the Player hand or the Banker hand;
determining whether the winning hand in the Baccarat game is the same as the wager placed in the step of receiving;
responsive to the outcome of the Baccarat game and according to predetermined rules for the Bigger Win side bet, determining whether the wager placed in the step of receiving is a winning wager in the Baccarat game and on the Bigger Win side bet,
dispensing a payout according to a predetermined payout table if the wager placed in the step of receiving is a winning wager, and
allowing the gambler to redeem the Variable Value Tokens for a current monetary value, wherein the step of allowing the gambler to redeem is subject to one or more conditions,
wherein a first condition of the one or more conditions is that the gambler may perform the step of redeeming the Variable Value Tokens for 100% of the current monetary value if the current monetary value of the Variable Value Tokens is twice or more the initial face value of the Variable Value Tokens,
wherein a second condition of the one or more conditions is that the gambler may perform the step of redeeming the Variable Value Tokens for 50% of the current monetary value if the current monetary value of the Variable Value Tokens is in a range of from half of the initial cost of the Variable Value Tokens (that was paid by the gambler) to twice the initial face value of the Variable Value Tokens (non-inclusive of the end points),
wherein a third condition of the one or more conditions is that the gambler may perform the step of redeeming the Variable Value Tokens for 100% of the current monetary value if the current monetary value of the Variable Value Tokens is equal to or less than half the initial cost of the Variable Value Tokens (that was paid by the gambler) and more than zero,
wherein when the current monetary value of the Variable Value Tokens has been reduced to zero, a fourth condition of the one or more conditions is that the gambler may select from leaving the modified Baccarat game and purchasing one or more Variable Value Tokens to continue playing the modified Baccarat game,
wherein a fifth condition of the one or more conditions is that the gambler may perform the step of redeeming the Variable Value Tokens for the current monetary value only if a cumulative total amount won by the gambler is an amount at least five times the initial face value of the Variable Value Tokens.
